(19) United States
(12) Patent Application Publication
(10) Pub. No.: US 2008/0305978 A1
(43) Pub. Date: Dec. 11, 2008

(54) Cleaning compositions containing a hydrophilic fragrance

(75) Inventors: John R. Wietfeldt, Franksville, WI (US); Francis J. Randall, Racine, WI (US); Jacqueline V. Lepow, Franklin, WI (US); Padma Prabodh Varanasi, Racine, WI (US); Guy D. Daley, Racine, WI (US); Timothy L. Chaffee, Warren Center, PA (US); James J. Runkel, Racine, WI (US); Gerald W. Cummings, Racine, WI (US)

Correspondence Address: S.C. Johnson & Son, Inc., 1525 Howe Street, Racine, WI, 53403-2236, US

(73) Assignee: S.C. Johnson & Son, Inc., Racine, WI (US)

(21) Appl. No.: 11/808,305

(22) Filed: Jun. 8, 2007

(51) Int. Cl. C11D 7/26

(52) U.S. Cl. 510/109

(57) ABSTRACT

Cleaning compositions for hard glossy surfaces having reduced streaking and blooming based on the inclusion of a compatible fragrance or fragrance mixture therein is described. Compatible fragrance(s) are hydrophilic fragrances having a Delta value of 22 or less. The fragrance is maintained in solution in the absence of a solubilizer fragrance carrier.

### FIELD OF INVENTION

The invention is directed to cleaning compositions containing at least one hydrophilic fragrance which in use on glossy or shiny hard surfaces, e.g. glass, provides for reduced streaking and hazing or blooming of the surface. Further, the cleaning compositions of the invention provide the reduced streaking and hazing in the absence of a solubilizer carrier for the fragrance in the composition.

### BACKGROUND OF THE INVENTION

Various compositions are known in the art for application to hard surfaces, such as common household surfaces of glass, countertops, tile, metal appliances, and the like. Hard surfaces can be glossy or matte surfaces. In cleaning glossy surfaces, cleaning compositions can be problematic in that the prior art cleaning compositions often result in spotting or streaking or formation of film or haze thereon. Hydrophobic components, such as hydrophobic fragrances, included in the compositions contribute to these problematic characteristics. The compositions generally must include one or more additional components in the nature of a solubilizer or surfactant for the hydrophobic component, which adds cost to producing the composition. The hydrophobic fragrance and surfactant in the cleaning composition act like an oily soil following application and drying on a glossy surface, such as glass. This results in hazing, and usually streaking. Compositions for application to hard surfaces, which may include a hydrophilic fragrance, wherein the compositions reduce malodor on inanimate surfaces are known in the art. However, these compositions are described as preferably not being applied to shiny surfaces, such as glass, because spotting and filming more readily occur on these surfaces. The hydrophilic fragrances are disclosed as being more soluble in water and thus more available in the odor-absorbing composition than the ingredients of conventional perfumes.

For example, U.S. Patent Application Publication No. 2004/0127463 A1 discloses stable, aqueous odor-absorbing compositions, articles of manufacture, and/or method of use, including solubilized uncomplexed cyclodextrin, and optionally additional components such as cyclodextrin compatible antimicrobial active, cyclodextrin compatible surfactant, cyclodextrin compatible humectant, hydrophilic perfume providing improved acceptance, or mixtures thereof. Preferably, the perfume is hydrophilic and is composed predominantly of ingredients selected from two groups of ingredients, namely, (a) hydrophilic ingredients having a ClogP of less than about 3.5, and (b) ingredients having significant low detection threshold, and mixtures thereof. Typically, at least about 50%, preferably at least about 60%, more preferably at least about 70% and most preferably at least about 80% by weight of the perfume is composed of perfume ingredients of the above groups (a) and (b). The hydrophilic perfume ingredients are stated to be more soluble in water, have less of a tendency to complex with the cyclodextrins, and are more available in the odor-absorbing composition than the ingredients of conventional perfumes. In the method of use of the cyclodextrin solution, as described at page 19, paragraph 0241, the invention is stated to not encompass distributing the cyclodextrin solution onto shiny surfaces including, e.g., chrome and glass, because spotting and filming are stated to more readily occur on these surfaces. The invention, however, is stated to encompass a method of spraying an effective amount of the cyclodextrin solution onto household surfaces selected from the group consisting of countertops, cabinets, walls, floors, bathroom surfaces and kitchen surfaces.

U.S. Pat. Nos. 5,670,475, 5,939,060, 6,077,318, 6,146,621, 6,248,135 B1, 6,451,065 B2, and U.S. Patent Application Publication No. 2003/0005522 A1 disclose an aqueous composition for reducing malodor impression including a perfume which may be a hydrophilic perfume. When hydrophilic perfume is desired, at least about 25% by weight of the perfume, more preferably about 50%, most preferably about 75%, is composed of perfume ingredients having a ClogP of about 3 or smaller. The invention is stated to not encompass distributing the solution onto shiny surfaces including, e.g., chrome and glass, because spotting and filming can more readily occur on these surfaces. However, the invention is stated to encompass a method of spraying an effective amount of the composition for reducing malodor onto household surfaces which consist of countertops, cabinets, walls, floors, bathroom surfaces and kitchen surfaces.

U.S. Pat. Nos. 5,955,093 and 6,656,923 B1 (the '923 patent being a continuation-in-part of the '093 patent) disclose stable, aqueous odor-absorbing and wrinkle controlling compositions, preferably for use on inanimate surfaces, including solubilized, water-soluble, uncomplexed cyclodextrin; an aqueous carrier, and optionally a hydrophilic perfume. The hydrophilic perfume is composed predominantly of ingredients selected from two groups of ingredients, namely, (a) hydrophilic ingredients having a ClogP of less than about 3.5, and (b) ingredients having significant low detection threshold, and mixtures thereof. Typically, at least about 50%, preferably at least about 60%, more preferably at least about 70%, and most preferably at least about 80% by weight of the perfume is composed of perfume ingredients of the above groups (a) and (b).

U.S. Pat. No. 6,786,223 B2 discloses hard surface cleaners which provide improved fragrance retention properties to treated hard surfaces wherein the cleaners include a fragrance, a carrier, and a surfactant selected from ethylene oxide/propylene oxide block copolymers, polyglycosides, ethoxylated alkyl alcohols, and ethylene oxide/propylene oxide copolymers functionalized with a fatty acid moiety. The cleaners may also contain water and a base. The cleaners render the treated or clean surfaces hydrophilic and provide the surfaces with anti-fogging properties. The '223 patent discloses that the chemical structure of nearly every known fragrance contains hydrophilic domains (column 9, lines 21-22). The chemical structure of fragrances is also recognized as having hydrophobic domains (column 9, lines 27-29). These properties are stated to be useful in providing hard surface cleaners with improved release properties to hard surfaces. The patent teaches the attraction of hydrophilic forces to each other to provide for retention of the fragrance longer by rendering the hard surface hydrophilic.

U.S. Pat. No. 6,660,713 B2 discloses compositions for removing and controlling malodor on substrates including nanozeolite; a compatible carrier; and optional additional ingredients selected from surfactants, perfumes, preservatives, antimicrobials, de-foaming agents, antifoaming agents, bacteriocides, fungicides, antistatic agents, insect and moth repellents, colorants, bluing agents, antioxidants and mixtures thereof. When perfume is present in the composition, the perfume is stated to be preferably hydrophilic and is composed predominantly of ingredients selected from two groups of ingredients, namely, (a) hydrophilic ingredients having a ClogP of less than about 3.5 and (b) ingredients having significant low detection threshold, and mixtures thereof.

U.S. Pat. Nos. 6,669,391 B2, 6,854,911, 6,663,306 B2 and U.S. Patent Application Publication Nos. 2003/0127108 A1 and 2004/0226123 A1 disclose hard surface cleaning compositions, cleaning pads and cleaning implements wherein the cleaning compositions optionally include the following components: surfactant; hydrophilic polymer; organic solvent; mono- or polycarboxylic acid; odor control agent; a source of peroxide; thickening polymer; aqueous solvent system; suds suppressor; a perfume comprising (i) optionally, a volatile hydrophilic perfume material; (ii) optionally, a volatile, hydrophobic perfume material; (iii) optionally, a residual, hydrophilic perfume material; (iv) a residual, hydrophobic perfume material; and a detergent adjuvant. The volatile, hydrophilic perfume materials have a boiling point of less than about 250° C. and a ClogP of less than about 3. The volatile, hydrophilic perfume materials are described as tending to evaporate with the water contained in the compositions, which provides some odor to the room containing the treated surfaces. These materials are also described as not tending to leave visual filming and/or streaking on the treated surfaces. As a result, volatile, hydrophilic perfume materials typically comprise a relatively large portion of the perfumes.

The present invention upon application to a glossy or shiny surface reduces streaking and hazing of the surface as more fully described below.

### BRIEF DESCRIPTION OF THE INVENTION

The present invention involves cleaning compositions for glossy or shiny surfaces, e.g. glass, wherein the compositions contain one or more compatible fragrance(s) therein resulting in reduced streaking and hazing or blooming of the surfaces following application thereto. The compatible fragrances are hydrophilic fragrances which can be maintained in solution in the absence of a solubilizer fragrance carrier.

Compatible hydrophilic fragrances are a fragrance or fragrance mixture which is within an acceptable range of Delta values which calculation uses Hansen solubility parameters, i.e., Hansen dispersion, Hansen polarity and Hansen hydrogen bonding solubility parameters. By choosing fragrances within the acceptable range of Delta values, glass hazing is reduced. Fragrance mixtures with a high portion of hydrophilic components also result in reduced blooming and less streaking of a glossy/shiny surface.

An additional benefit of the cleaning compositions of the invention is that the addition of a fragrance solubilizer as a carrier for the fragrance is eliminated since a fragrance solubilizer is not needed to maintain the hydrophilic fragrances of the invention in solution in a cleaning composition. A solubilizer carrier for the fragrance refers to a solubilizing agent or surfactant premixed with the fragrance to provide and maintain the fragrance in a soluble form for mixing with other components of a cleaning composition and for good shelf life. The elimination of the solubilizer and such premixing provides a significant cost savings in the production of cleaning compositions.

Acceptable Delta values of hydrophilic fragrances suitable for use in the invention are 22 or less. The Delta value specifies the separation in solubility parameter space between two solvents or solvent and plastic to predict compatibility. The Delta value is Delta=[4×(δ_{D}−δ_{Dwater})²+(δ_{P}−δ_{Pwater})²+(δ_{H}−δ_{Hwater})²]^{1/2}. In determining the Delta value, Hansen parameters of hydrophilic fragrances are used, wherein δ_{D} is the dispersive or nonpolar parameter, δ_{P} is the polar parameter and δ_{H} is the hydrogen bonding parameter. Hydrophilic fragrances having Delta values within the above range when present in a cleaning composition for glossy or shiny surfaces serves to reduce the occurrence of streaking and hazing following application and drying of the cleaning composition on the surface. This effect is achieved in the absence of a solubilizer carrier for the fragrance.

Additionally, to further improve the fragrance effect in a cleaning composition, surfactant(s) of the cleaning composition including a fragrance having an acceptable Delta value will preferably have a high HLB (hydrophilic/lipophilic balance) value, i.e., a value equal to or greater than 12. Generally, anionic surfactants are preferred for use in cleaning compositions in particular in glass cleaners. The HLB of anionic surfactants is not well-defined, but is recognized as being high. This provides good water solubility characteristics to the overall cleaning composition and further compatibility with the fragrance.

### DESCRIPTION OF DRAWING

FIG. 1 illustrates the effect of fragrance concentration based on amounts on hazing/blooming over 10 days following application to a glass surface using a fragrance commercially available from International Flavors & Fragrances (IFF).

FIG. 2 illustrates the effect of fragrances of varying amounts following a period of 25 days following application to a glass surface.

FIGS. 3(a) to 3(d) illustrate statistical correlation as to the data of Tables 2 and 3 set forth below as to certain fragrance samples.

### DETAILED DESCRIPTION OF THE INVENTION

Hydrophobic fragrances have been identified as a significant source of hazing on glossy or shiny surfaces, such as glass, following cleaning of such surfaces with a cleaning composition containing a hydrophobic fragrance. Generally, fragrances are not a single fragrance component, but rather are blends of fragrances. Accordingly, while a fragrance may be described as being hydrophobic or hydrophilic, this is a characterization based on the predominant component therein. The invention involves cleaning compositions for glossy or shiny surfaces, such as glass, having one or more fragrances that are compatible with the components of the cleaning composition, in particular hydrophilic fragrances. Hydrophilic fragrances suitable for use have Delta values within a predetermined range. Hydrophilic fragrances having Delta values within this optimized range when used in glossy hard surface cleaning compositions serve to reduce hazing or film formation on the surface cleaned therewith as well as streaking on the surface.

Further, no fragrance solubility agent or surfactant is required as a carrier for the fragrance when using one or more hydrophilic fragrances as described herein. When a fragrance outside the Delta value range of invention, e.g. hydrophobic fragrances or blends of hydrophobic and hydrophilic fragrances, is included in a cleaning composition, a fragrance solubilizer carrier is also required since hydrophobic fragrances act as an oily soil during application of the cleaning composition to a glossy surface. A fragrance solubilizer or surfactant serves to reduce this effect of a hydrophobic fragrance.

The Delta value system is a known system used for evaluating solubility of various components, e.g. solvents, so as to provide a standard by means of which various components can be differentiated. Particularly, the Delta value specifies the separation in solubility parameter space between two solvents or solvent and plastic to predict compatibility. The Delta value is expressed as follows:

Delta=[4×(δ_{D}−δ_{Dwater})²+(δ_{P}−δ_{Pwater})²+(δ_{H}−δ_{Hwater})²]^{1/2}

where δ_{D}, δ_{P}, and δ_{H} are Hansen solubility parameters
where δ_{D}=Dispersive or nonpolar parameter,
   δ_{P}=Polar parameter, and
   δ_{H}=Hydrogen bonding parameter.
      The solubility parameters serve to define a solubility area upon plotting on a three-dimensional graph to define a “solubility space” by which different components, in this instance fragrances, can be compared. Calculation of the Hansen solubility parameters can be made using the Molecular Modeling Pro (MMP), Revision 1.21 by NorGwyn Montgomery Software, published by Windowchem® 1992-1995. Water solubility may be estimated using the method of Klopman, G., Wang, S. et al, J. Chem. Sci. 32, 474-482 (1992) as discussed in Chemical Property Estimation: Theory and Application, Edward J. Baum, Lewis Publishers (1997), Sec. 7.3 entitled “Methods of estimating aqueous solubility”, pages 77-81. The Klopman method is based on breaking down a molecule into its parts. Another calculation, also known in the art which can be correlated to the Delta value or Klopman method, is the Log P. Log P is the partition coefficient between octanol and water. Log P can be calculated from structure using Molecular Modeling Pro software as described above. The The Delta values of hydrophilic fragrances suitable for use in the invention are 22 or less, preferably 21 or less and more preferably 20 or less.

Examples of fragrances or fragrance mixtures are set forth in Table 1 below. Those fragrances or fragrance mixtures having a Delta value of 22 or less are suitable for use in cleaning compositions for glossy surfaces to achieve reduction in hazing and streaking following application of the cleaning composition to such surface.

TABLE 1

| | | | | | Delta |
|---|---|---|---|---|---|
| | | | | | vs. |
| Fragrance | CAS NUMBER | δ_{N} | δ_{P} | δ_{H} | Water |
| Aldehyde MNA | 110-41-8 | 16.1 | 2.2 | 4.5 | 23.7 |
| Allyl Amyl Glycolate | 67634-00-8 | 17.1 | 0.0 | 5.5 | 25.3 |
| Allyl heptanoate | 142-19-8 | 16.6 | 3.0 | 5.5 | 22.5 |
| Applinal = Fructone | 6413-10-1 | 19.7 | 4.9 | 0.0 | 24.6 |
| alpha-terpinene | 99-86-5 | 16.2 | 1.0 | 4.6 | 24.7 |
| alpha-terpineol | 98-55-5 | 16.1 | 4.6 | 11.2 | 19.3 |
| alpha-terpinyl acetate | 80-26-2 | 16.1 | 2.4 | 5.8 | 23.0 |
| Benzyl acetate | 140-11-4 | 16.4 | 4.3 | 7.3 | 20.6 |
| Benzyl Alcohol | 100-51-6 | 18.4 | 6.3 | 13.7 | 17.7 |
| Benzyl propionate | 122-63-4 | 16.5 | 4.2 | 6.3 | 21.1 |
| Camphor | 76-22-2 | 16.7 | 4.3 | 4.3 | 21.9 |
| Cineole | 470-82-6 | 16.1 | 2.8 | 5.7 | 22.6 |
| Citronellol | 26489-01-0 | 17.4 | 2.9 | 10.7 | 21.1 |
| Cyclamen aldehyde | 103-95-7 | 17.6 | 2.5 | 5.0 | 23.3 |
| Dihydromyrcenol | 18479-58-8 | 16.0 | 4.3 | 10.7 | 19.7 |
| Eugenol | 97-53-0 | 16.8 | 6.7 | 11.7 | 17.1 |
| Geraniol | 106-24-1 | 17.1 | 4.2 | 10.1 | 19.9 |
| Hexyl acetate | 142-92-7 | 16.1 | 2.9 | 5.7 | 22.5 |
| Hexyl cinnamic | | 17.9 | 2.2 | 5.5 | 23.4 |
| aldehyde | | | | | |
| Isobornyl acetate | 000125-12-2 | 16.0 | 2.5 | 5.3 | 23.1 |
| Ligastal = Triplal | 68039-49-6 | 15.2 | 3.1 | 6.5 | 22.1 |
| Lilial | 80-54-6 | 17.3 | 2.3 | 4.8 | 23.5 |
| Limonene | 5989-27-5 | 16.2 | 1.0 | 4.7 | 24.7 |
| Linalyl acetate | 1118-39-4 | 16.0 | 2.3 | 6.4 | 22.8 |
| Linalool | | 15.9 | 4.4 | 11.3 | 19.4 |
| Menthol | | 15.6 | 0.6 | 3.2 | 25.7 |
| Phenylethanol | 60-12-8 | 19.4 | 4.3 | 13.5 | 20.2 |
| Ortholate = Verdox | 88-41-5 | 15.6 | 2.2 | 5.0 | 23.5 |
| PTBCHA = Vertenex | 32210-23-4 | 15.6 | 2.2 | 5.0 | 23.5 |
| Water | | 16.5 | 23.5 | 14.8 | 0.0 |

Hydrophilic fragrances having Delta values of 22 or less as defined above do not require the use of a solubilizer or surfactant as a carrier for the fragrance to provide solubilization of the fragrance(s) and maintenance in solution in a cleaning composition.

To illustrate the correspondence of the different calculation methods, examples are set forth below in Table 2, using four different fragrances and water.

TABLE 2

| | | | | | Klopman | 25 day |
|---|---|---|---|---|---|---|
| | | | MMP | | % | Bloom |
| | | Delta | water | | water | Rating |
| | | vs. | solubility | MMP | aqueous | Black |
| Fragrance | CAS Number | water | g/L | Log P | solubility | Box |
| Lilial | 80-54-6 | 23.5 | 0.027 | 4.508 | 0.015 | 7.7 |
| Dihydromyrcenol | 18479-58-8 | 19.7 | 0.862 | 2.973 | 0.262 | 3.6 |
| Applinal (Fructone) | 6413-10-1 | 24.6 | 3.08 | 0.3642 | 0.677 | 5.5 |
| Limonene | 5989-27-5 | 24.7 | 0.11893 | 4.362 | 0.029 | 7 |

The procedure regarding the “Black Box” test is described below in relation to Test 1. Correlation of the data is set forth in Table 3 below.

TABLE 3

| | | | | | Bloom |
|---|---|---|---|---|---|
| | Delta | MMP | | Klopman | Rating |
| | vs. | water | | % water | @ 25 |
| | Water | solubility | Log P | solubility | day |
| Delta vs. | 1 | | | | |
| Water | | | | | |
| MMP | 0.18 | 1 | | | |
| water | | | | | |
| solubility | | | | | |
| Log P | −0.08 | −0.99 | 1 | | |
| Klopman | 0.07 | 0.99 | −1.00 | 1 | |
| % water | | | | | |
| solubility | | | | | |
| Bloom | 0.76 | −0.42 | 0.51 | −0.51 | 1 |
| Rating | | | | | |
| @ 25 | | | | | |
| day | | | | | |

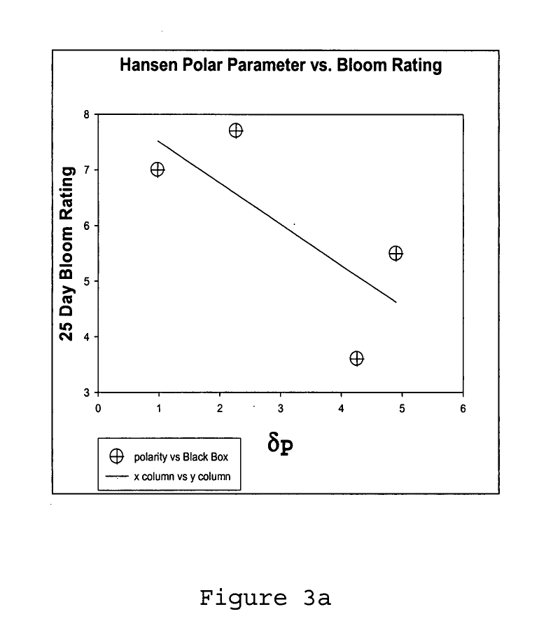

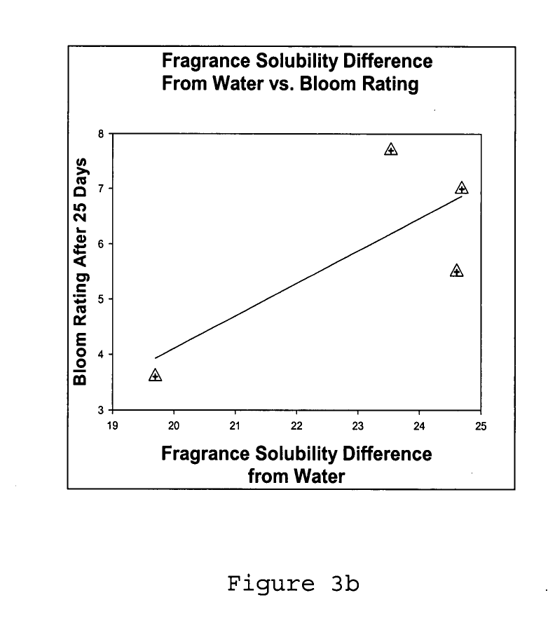

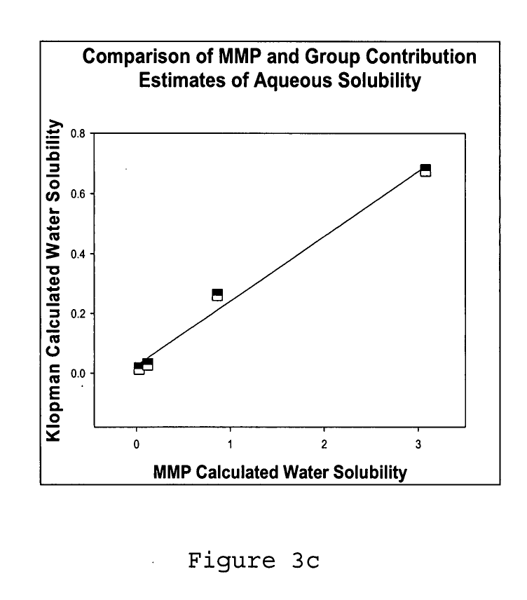

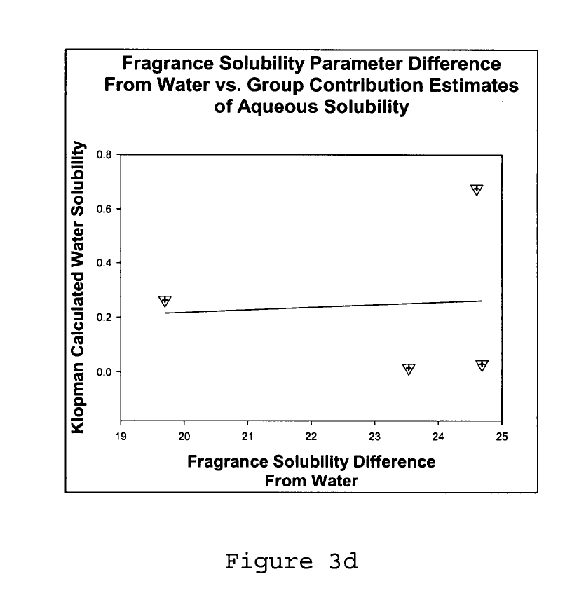

The statistical correlation of the data calculated is illustrated in FIGS. 3(a)-3(d). The trends illustrated show positive correlation. It is noted that data on the water solubility of fragrance compounds is only minimally available in the literature. Consequently, estimation methods must be used. Table 2 illustrates estimation of water solubility for the identified fragrances. The water solubility calculated for the four fragrance ingredients by Klopman's method is highly correlated with that calculated by Molecular Modeling Pro (MMP) and with the calculated Log P. The Delta difference vs. water provides good correlation with blooming rating. Thus, the Delta value estimate of water solubility is a good calculator for these determinations.

Cleaning compositions for glossy or shiny surfaces such as glass, generally contain in admixture with water a blend of surfactant(s), solvent(s), pH adjustor(s), fragrance(s) and colorant(s). The surfactant(s) can be selected from various anionic, nonionic and/or amphoteric surfactants as known in the cleaning art. Solvent(s) include mono- or polyhydric alcohols, such as for example alkyl alcohols, alkylene glycols, and alkylene glycol ethers.

Examples of surfactants include, alkyl benzene sulfates or sulfonates, alkyl polyglycosides, secondary alcohol ethoxylates, acrylic polymer surfactants, alkylsulphophenoxy benzenes, alkyl sulfonates. The surfactants selected for providing the cleaning compositions preferably have a high HLB value, i.e., a value equal to or greater than 12. This serves to further improve the water-solubility of the composition and enhance the fragrance effect.

Examples of solvents include primary or secondary alcohols, alkylene glycol alkyl ethers, and alkylene glycols.

Examples of pH adjustors are ammonium hydroxide, alkali metal or alkaline hydroxides, and monoalkanolamines.

An example of a glossy hard surface cleaning composition suitable for inclusion of one or more hydrophilic fragrances within the invention is as follows:

| Ingredient | Wt. % Range |
|---|---|
| Water | ~93-95 |
| Alkane Alcohol(s) | ~1-4 |
| Alkylene Glycol Alkyl Ether(s) | ~0.5-4 |
| Amphoteric Surfactant(s) | ~0.1-1.5 |
| Alkylene Glycol(s) | ~0.2-0.3 |
| Nonionic Surfactant(s) | ~0.1-3 |
| Anionic Surfactant(s) | ~0-0.2 |
| Hydroxide Salt(s) | ~0.06-0.3 |
| Alkanolamine(s) | ~0.2-0.6 |
| Fragrance(s) | −0.01-0.3 |
| Dye(s) | −0-0.01 |
| | 100% |

To illustrate the surprising effect of a hydrophilic fragrance in a hard glossy surface cleaning composition, test results relating thereto are described below.

Test 1

First, tests were conducted on typical components of a glass cleaning composition to illustrate the effect on streaking and blooming (hazing) of these components, in particular a hydrophobic fragrance. In these tests, glass panels were cleaned with components of a glass cleaning composition and were tested to determine which component(s) tended to increase streaking/blooming. More particularly, blooming was measured as light scattering from 12 inch square float glass panels after the panels are cleaned and treated with a glass cleaner. A standard technique was used to prepare streak free clean glass panels and treat them on the non-tinted side with glass cleaner. Wiping was performed using a paper towel, or specified wipe wrapped on a paddle for a single pull across the glass. Subsequently, the glass panels were stored under controlled conditions and evaluated for light scattering periodically using a Scatterometer over a period of about 3 weeks and expressed as the average grey scale light scattering parameter.

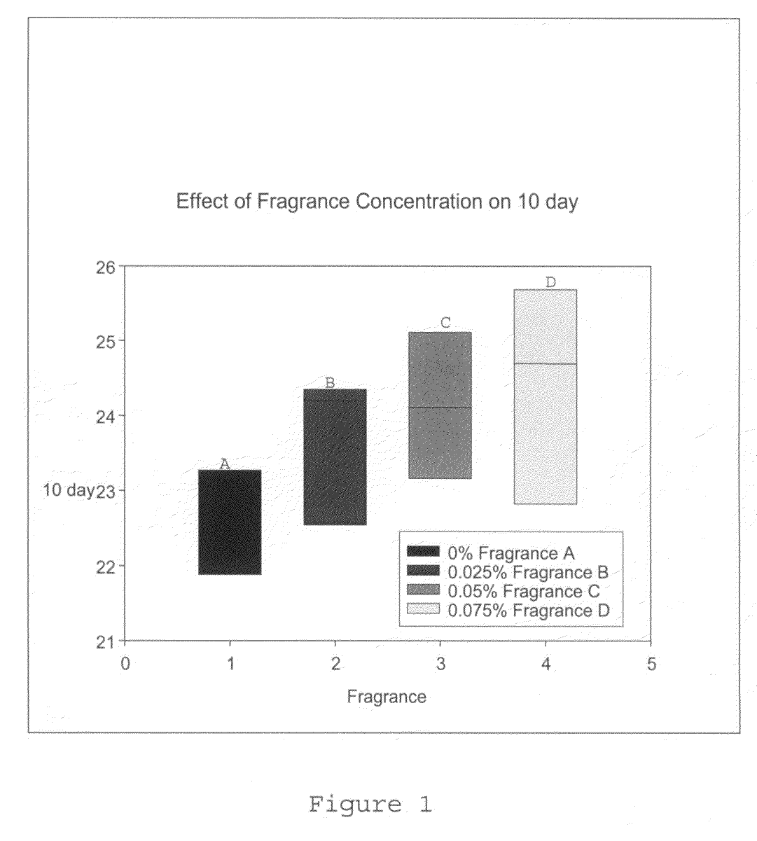

Test products (with components shown in wt. %) as used in the testing is set forth below in Table 4. This dataset is a Monte Carlo design set up using the method described at pages 488-497 in CHEMTECH by Charles Hexdrix (August 1980). In addition, each test product contained 1% of Liquitint blue dye. The effect of the components or the test products on the glass surface was measured at over a 10 day period after application and compared to untreated glass. As shown in FIG. 1, variation of the fragrance concentration did affect the streaking/blooming of the hydrophobic fragrance tested. Regression produced the following linear model of the effect of component levels on blooming at ten days (Blooming_{10 days}=25.1813−0.3807*% Isopropanol+0.02981*% Hexyl Cellosolve−0.9485*% Propylene Glycol−0.408*% Ammonia−1.3384*% Monoethanolamine−0.909*% MACKAM (Disodium Cocoamphodipropionate)−3.9968*% Polyquart (aqueous acrylic polymer)+23.445*% IFF (fragrance)). Thus, the effect on (i.e., increase or decrease relative to day 0) streaking/blooming was shown to be positively associated with the fragrance concentration, even though fragrance levels are very low in these formulations.

TABLE 4

| | | Hexyl | Propylene | | | MACKAM | | | Bloom |
|---|---|---|---|---|---|---|---|---|---|
| run | isopropanol | Cellosolve | Glycol | NH4OH | MEA | 2CSF | POLYQUART | IFF | @10 day |
| 1 | 1.5 | 0.0 | 0.125 | 0.15 | 0.3 | 0.6 | 0.0 | 0.000 | 23.12 |
| 2 | 3.0 | 0.9 | 0.125 | 0.45 | 0.6 | 0.3 | 0.3 | 0.000 | 21.53 |
| 3 | 4.5 | 0.9 | 0.375 | 0.30 | 0.3 | 0.6 | 0.1 | 0.075 | 22.45 |
| 4 | 1.5 | 0.0 | 0.125 | 0.30 | 0.6 | 0.9 | 0.0 | 0.075 | 23.93 |
| 5 | 1.5 | 0.9 | 0.375 | 0.45 | 0.6 | 0.6 | 0.1 | 0.050 | 24.13 |
| 6 | 0.0 | 0.9 | 0.000 | 0.30 | 0.9 | 0.6 | 0.2 | 0.050 | 24.08 |
| 7 | 0.0 | 0.3 | 0.125 | 0.15 | 0.6 | 0.9 | 0.3 | 0.050 | 23.29 |
| 8 | 0.0 | 0.0 | 0.125 | 0.00 | 0.3 | 0.0 | 0.2 | 0.025 | 24.05 |
| 9 | 1.5 | 0.6 | 0.000 | 0.00 | 0.6 | 0.3 | 0.0 | 0.015 | 25.77 |
| 10 | 3.0 | 0.3 | 0.000 | 0.00 | 0.3 | 0.3 | 0.2 | 0.075 | 25.46 |
| 11 | 0.0 | 0.6 | 0.000 | 0.15 | 0.6 | 0.3 | 0.1 | 0.000 | 23.09 |
| 12 | 0.0 | 0.9 | 0.000 | 0.15 | 0.9 | 0.0 | 0.0 | 0.000 | 24.35 |
| 13 | 3.0 | 0.0 | 0.250 | 0.15 | 0.0 | 0.3 | 0.0 | 0.050 | 25.00 |
| 14 | 1.5 | 0.6 | 0.375 | 0.15 | 0.9 | 0.6 | 0.2 | 0.000 | 21.88 |
| 15 | 0.0 | 0.3 | 0.375 | 0.30 | 0.6 | 0.3 | 0.0 | 0.025 | 24.35 |
| 16 | 1.5 | 0.6 | 0.250 | 0.30 | 0.6 | 0.9 | 0.0 | 0.025 | 24.36 |
| 17 | 1.5 | 0.9 | 0.375 | 0.45 | 0.0 | 0.0 | 0.0 | 0.050 | 25.46 |
| 18 | 3.0 | 0.6 | 0.375 | 0.45 | 0.3 | 0.6 | 0.3 | 0.000 | 22.19 |
| 19 | 0.0 | 0.3 | 0.375 | 0.45 | 0.0 | 0.3 | 0.3 | 0.000 | 23.28 |
| 20 | 3.0 | 0.9 | 0.125 | 0.00 | 0.6 | 0.6 | 0.3 | 0.025 | 22.03 |
| 21 | 3 | 0.6 | 0.25 | 0.3 | 0.6 | 0.6 | 0.2 | 0.05 | 22.75 |

NH₄OH = Ammonium hydroxide
MEA = Monoethanolamine
MACKAM 2CSF = Amphoteric, disodium cocoamphodipropionate
POLYQUART = Aqueous Acrylic Polymer
IFF = Commercially available hydrophobic fragrance

The method of evaluation, the Black Box method, using a Scatterometer device to measure the streaks or residue left on glass after cleaning is based on measuring the diffuse transmitted light scattered from residue on glass. The meter device has a light-tight box including (1) a sliding vertical mount for a 12×12 inch sliding window panel, (2) a set of bright lights to obliquely illuminate one side of the glass panel and (3) a camera system to image the glass panel from the side opposite the lights against a dark background. The system uses image analysis to measure average brightness of the glass panel image to obtain a measurement score. The higher the measurement score, the more streaks or blooming that are present. Average brightness is the average grey scale value of pixels in the panel image. Either the raw meter score or the difference meter score, which is found by subtracting the score of the same clean glass panel taken before the test, is used. When testing cleaning compositions with the meter device, scores are often found to increase with time after using a cleaning composition, so comparisons between different products or components are limited to the same test and time after application.

Test 2

This test evaluated properties of fragrances with different levels of water solubility with regard to their effect on contributing to streaking/blooming. The fragrance components tested are set forth in Table 5 below.

TABLE 5

| | Vapor | Water | |
|---|---|---|---|
| Fragrance | Pressure | Solubility, Klopman | |
| Components | mm/Hg | Calculation % | Characteristics |
| Lilial | 0.004 | 0.015 | (1) Low vapor |
| | | | pressure |
| | | | (2) Easily oxidized |
| | | | (3) Low water |
| | | | solubility |
| Dihydromyrcenol | 0.7 | 0.262 | (1) Fairly high |
| | | | vapor |
| | | | pressure |
| | | | (2) Reasonable |
| | | | water solubility |
| Applinal | — | 0.677 | High water |
| | | | solubility |
| Orange terpene | 2.1 | 0.029 | (1) High vapor |
| (mainly limonene) | | | pressure |
| | | | (2) Low water |
| | | | solubility |
| IFF | | | Low, but unknown, |
| Commercial Blend | | | water solubility |

The “IFF” fragrance component of Table 5 is the same hydrophobic fragrance component tested in TEST 1. The IFF fragrance includes a nonionic ethoxylated alcohol surfactant as the solubilizer carrier for the fragrance. The fragrances of Table 1 were tested using the same Scatterometer device used and described above in TEST 1 and also used in TEST 2. The results for TEST 2 are set forth below.

TABLE 6

| | | Meter Reading | | |
|---|---|---|---|---|
| | | | Standard | Water |
| Treatment | | Mean | Deviation | Solubility |
| (1) | Glass Cleaner^{A} w/IFF | 13.00 | 1.99 | |
| | fragrance and solubilizer | | | |
| (2) | Glass Cleaner w/solubilizer | 13.24 | 4.97 | |
| | and w/o IFF fragrance^{B} | | | |
| (3) | Glass Cleaner w/IFF | 11.55 | 3.01 | IFF is low |
| | fragrance and w/o solubilizer^{C} | | | |
| (4) | Glass Cleaner w/o solubilizer | | | |
| | and w/o IFF fragrance^{D} but with - | | | |
| | (a) Lilial | 7.72 | 4.07 | Low |
| | (b) Dihydromyrcenol | 3.56 | 3.18 | Medium |
| | (c) Applinal | 5.49 | 1.02 | High |
| | (d) Orange Terpene | 6.95 | 4.12 | Low |

A Glass Cleaner includes as components

| Component | wt. % |
|---|---|
| Isopropanol | 3.0 |
| Hexyl Cellosolve | 0.6 |
| Propylene Glycol | 0.25 |
| Ammonium Hydroxide (30%) | 0.3 |
| Monoethanolamine | 0.6 |
| Disodium Cocoamphodipropionate | 0.6 |
| Secondary Alcohol Ethoxylate | 0.15 |
| Aqueous Acrylic Polymer | 0.2 |
| IFF Hydrophobic Fragrance | 0.05 |
| Blue Dye (1%) | 1.0 |
| Soft Water | 93.25 |

wherein an ethoxylated alcohol solubilizer is premixed with the IFF fragrance to hold the fragrance in solution.
B Same cleaner as in 1 but not containing a fragrance.
C Same cleaner as in 1 containing the fragrance but not containing the ethoxylated alcohol fragrance solubilizer.
D Same cleaner as in 1 but not containing the ethoxylated alcohol fragrance solubilizer and not containing the IFF fragrance, but with a fragrance as set forth in Table 5.

From a comparison of the results of (1), (2) and (3) where (1) and (3) contain a hydrophobic fragrance and (2) contains no fragrance with (4)(a)-(4)(d) which contain fragrances of varying water solubility, it can be seen that the latter have lower meter scores and, thus, have less streaking and blooming. The Delta value and Hansen solubility parameters for (4)(a)-(4)(d) and IFF fragrance are shown below in Table 7.

TABLE 7

| Fragrance | | | | Delta |
|---|---|---|---|---|
| Components | δ_{D} | δ_{P} | δ_{H} | Value |
| Lilial | 17.3 | 2.3 | 4.8 | 23.5 |
| Dihydromyrcenol | 16.0 | 4.3 | 10.7 | 19.7 |
| Applinal | 19.7 | 4.9 | 0.0 | 24.6 |
| Orange terpene | 16.2 | 1.0 | 4.7 | 24.7 |
| (mainly limonene) | | | | |
| IFF | ~17 | ~2 | ~5 | ~23.6 |

The above tests show that the nature of the fragrance influences the score, independent of the presence of a solubilizer. Additionally, the test shows that the degree of water solubility is not indicative of a fragrance suitable for use in the absence of a solubilizer. For example, applinal having high water solubility had a Delta value greater than 22. It is noted that the base size of the test does not allow for significant differences to be shown. Thus, differences will be increased in conventional usage of the test compositions.

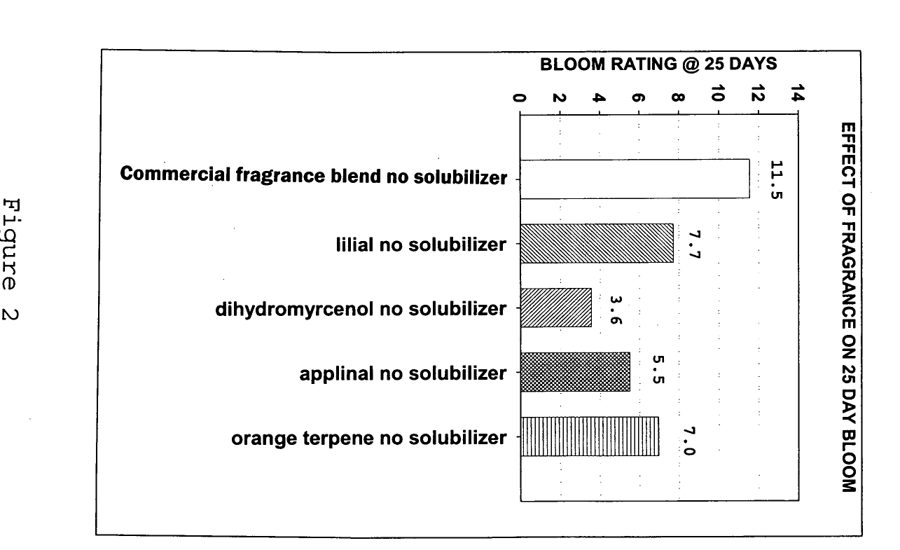

FIG. 2 sets forth the effect of the fragrance upon testing at 25 days following application to a glass test panel using the Scatterometer device as described in TEST 1. The lower the mean score, the less streaking/blooming present. The mean scores with standard deviation for the fragrances tests and shown in FIG. 2 are as follows:

| Fragrance | Mean | Standard Deviation |
|---|---|---|
| IFF Commercial Blend, no | 11.5 | 3.0 |
| solubilizer | | |
| Lilial, no solubilizer | 7.7 | 4.1 |
| Dihydromyrcenol, no | 3.6 | 3.2 |
| solubilizer | | |
| Appinal, no solubilizer | 5.5 | 1.0 |
| Orange Terpene, no | 7.0 | 4.1 |
| solubilizer | | |

The test results show that the fragrance components alone do significantly affect blooming.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. Cleaning composition for hard surfaces comprising
at least one surfactant;
at least one mono- or polyhydroxy compound;
at least one hydrophilic fragrance having a Delta value of 22 or less; and
water.

2. Cleaning composition according to claim 1, wherein said at least one fragrance is provided in absence of a solubilizer carrier compound for said at least one hydrophilic fragrance.

3. Cleaning composition according to claim 1, wherein said at least one surfactant has an HLB equal to or greater than 12.

4. Cleaning composition according to claim 3, wherein said at least one surfactant is one or more of an anionic, amphoteric, nonionic and cationic surfactant.

5. Cleaning composition according to claim 1, wherein said at least one mono- or polyhydroxy compound is selected from a group consisting of primary alcohols, secondary alcohols, alkylene glycols, and alkylene glycol ethers.

6. Cleaning composition according to claim 1, wherein said at least one fragrance is dihydromyrecenol.

7. Cleaning composition according to claim 1, wherein said at least one fragrance is terpineol.

8. Cleaning composition according to claim 1, wherein said at least one fragrance is benzyl alcohol.

9. Cleaning composition according to claim 1, wherein said at least one fragrance is geraniol.
